(19) United States
(12) Patent Application Publication
(10) Pub. No.: US 2025/0088742 A1
(43) Pub. Date: Mar. 13, 2025

(54) Camera Preview Stabilization

(71) Applicant: Apple Inc., Cupertino, CA (US)

(72) Inventors: Tao Zhang, Campbell, CA (US); Avijit S. Wasu, Santa Clara, CA (US); Florian Ciurea, Campbell, CA (US); Joshua B. Shagam, Redwood City, CA (US); Richard J. Shields, Sunnyvale, CA (US); Zejing Wang, Mountain View, CA (US)

(21) Appl. No.: 18/621,956

(22) Filed: Mar. 29, 2024

Related U.S. Application Data
(60) Provisional application No. 63/581,825, filed on Sep. 11, 2023.

(51) Int. Cl. H04N 23/68

(52) U.S. Cl. CPC H04N 23/6811

(57) ABSTRACT

Stabilizing camera preview frames involves obtaining preview frames and associated camera motion signals, smoothing out the trajectory of these frames to correct for camera movement, and then displaying the corrected frames. The process includes comparing current and prior preview frames and their motion signals to calculate smoothed trajectories and apply appropriate rotation and translation corrections. The specifics of trajectory smoothing take into account factors such as motion state, lighting, or capture mode, which can influence the strength of the smoothing parameter. Transform matrices are utilized based on correction rotation to adjust sample points within images, and special considerations like camera sag are factored into the image corrections.

### TECHNICAL FIELD

This disclosure relates generally to the field of digital image processing. More particularly, but not by way of limitation, it relates to techniques for achieving stable preview images during image capture preview.

### BACKGROUND

Image zooming is a commonly used feature in modern electronic image capture devices, such as smartphones, tablets, and other devices with embedded digital cameras. Various types of user interface (UI) elements or controls may be provided to users to control a desired zoom level during video capture operations, e.g., buttons, sliders, dials, gestures, audio and/or text commands, etc.

In order to produce “preview” videos (i.e., videos that are streamed from an image capture device to a display of an electronic device as the video images are being captured) and/or “recorded” videos (i.e., videos that may be processed and saved to non-volatile memory after the conclusion of the video image capture operations), a user may hold an electronic device having one or more cameras in the direction of the scene to be captured. However, when a user of an electronic device moves the electronic device while capturing the video, the preview videos may appear unstable. The effect is even more apparent when the user uses a video zoom operation during video image capture operations. Because of the limited field of view in a zoomed state, the preview video may appear even more unstable, thereby leading to an unpleasant user experience.

Thus, what is needed is an approach to leverage various technological improvements to the control of image capture device hardware—as well as to the software stack responsible for processing of images captured by such image capture devices—to provide a smoother video preview presentation during video image capture operations, thereby also improving the quality and smoothness of the recorded videos and providing for a better overall user experience.

### SUMMARY

Electronic devices, methods, and program storage devices for stabilizing preview images are disclosed herein. In particular, unintentional movements, for example by a user holding an image capture device, can cause the preview image to appear jittery. The effect is exaggerated when viewing a preview image using a zoom function. Without applying a stabilization technique to the preview image, the unintended motion across frames can lead to an unpleasant user experience.

The techniques described herein to improve the camera preview stabilization include: obtaining a first preview frame captured by a camera device, and obtaining first camera motion signals associated with the first preview frame and prior camera motion signals associated with a prior preview frame. A smoothed trajectory is determined for the first preview frame based on the first camera motion signals and second camera motion signals. A correction rotation is determined based on the smoothed trajectory for the first preview frame, and a correction translation is determined based on the correction rotation. The correction translation is applied to the first preview frame to obtain a corrected first preview frame, and the corrected first preview frame is displayed.

According to some embodiments, determining the smoothed trajectory for the first preview frame includes determining a trajectory for the first preview frame, obtaining a smoothed trajectory for the prior preview frame, and determining the smoothed trajectory for the first preview frame based on the trajectory for the first preview frame and the smoothed trajectory for the prior preview frame. A smoothing strength parameter may be applied which blends between to the smoothed trajectory for the prior preview frame and the trajectory for the first preview frame. The smoothing strength parameter may be based on, for example, a motion state of the camera device, a lighting condition around the camera device, and/or may be based on a capture mode associated with the first preview frame.

According to some embodiments, determining the correction translation may include determining a transform matrix based on the determined correction rotation, and applying the transform matrix to a sample point in the first preview image to determine the correction translation.

In some embodiments, the correction translation may additionally address other factors that cause an inconsistency between the preview image and a resulting captured image. For example, the corrected translation may be adjusted in accordance with an estimated sag of the camera device, according to one or more embodiments.

As mentioned above, various electronic device embodiments are disclosed herein. Such electronic devices may include, for example: a display; a user interface; one or more processors; a memory coupled to the one or more processors; and one or more image capture devices. According to one embodiment, instructions may be stored in the memory; the instructions, when executed, cause the one or more processors to perform the techniques described above and herein.

Various methods of performing improved camera preview stabilization are also disclosed herein, in accordance with the various electronic device embodiments enumerated above. Non-transitory program storage devices are also disclosed herein, which non-transitory program storage devices may store instructions for causing one or more processors to perform operations in accordance with the various electronic device and method embodiments enumerated above.

### BRIEF DESCRIPTION OF THE DRAWINGS

FIG. 1 illustrates an exemplary camera preview stabilization framework, according to one or more embodiments.

FIG. 2 illustrates, in flowchart form, a technique for applying a corrected translation to a preview image in accordance with one or more embodiments.

FIG. 3 shows, in flowchart form, additional detail for a technique for applying a corrected translation to a preview image in accordance with one or more embodiments.

FIG. 4 is an example of a state machine for motion states used to stabilize a preview image, according to one or more embodiments.

FIG. 5 is an exemplary framework for adjusting for sag in a preview image, according to one or more embodiments.

FIGS. 6A-6B are flowcharts illustrating techniques for determining a correction translation, in accordance with one or more embodiments.

FIG. 7 is a block diagram illustrating a programmable electronic computing device, in which one or more of the techniques disclosed herein may be implemented.

### DETAILED DESCRIPTION

Embodiments described herein are directed to a process for stabilizing camera images in real-time, for example during preview image capture. The technique involves collecting data from camera movements and using the camera movement data to smooth out the frames of the resultant video. The technique calculates a “smoothed trajectory” by comparing the movement from the current and previous frames and applying corrections to reduce apparent shakiness across frames. This smoothing can be adjusted based on various factors, such as the camera's motion and environmental lighting. Additionally, the techniques described herein can be used to address other discrepancies between a preview image and a captured image, such as a sag in the frame. The end result is a more stable preview image display for the user.

In the following description, for purposes of explanation, numerous specific details are set forth in order to provide a thorough understanding of the inventions disclosed herein. It will be apparent, however, to one skilled in the art that the inventions may be practiced without these specific details. In other instances, structure and devices are shown in block diagram form in order to avoid obscuring the inventions. References to numbers without subscripts or suffixes are understood to reference all instances of subscripts and suffixes corresponding to the referenced number. Moreover, the language used in this disclosure has been principally selected for readability and instructional purposes, and it may not have been selected to delineate or circumscribe the inventive subject matter, and, thus, resorting to the claims may be necessary to determine such inventive subject matter. Reference in the specification to “one embodiment” or to “an embodiment” means that a particular feature, structure, or characteristic described in connection with the embodiments is included in at least one embodiment of one of the inventions, and multiple references to “one embodiment” or “an embodiment” should not be understood as necessarily all referring to the same embodiment.

### Exemplary Camera Preview Stabilization Operations

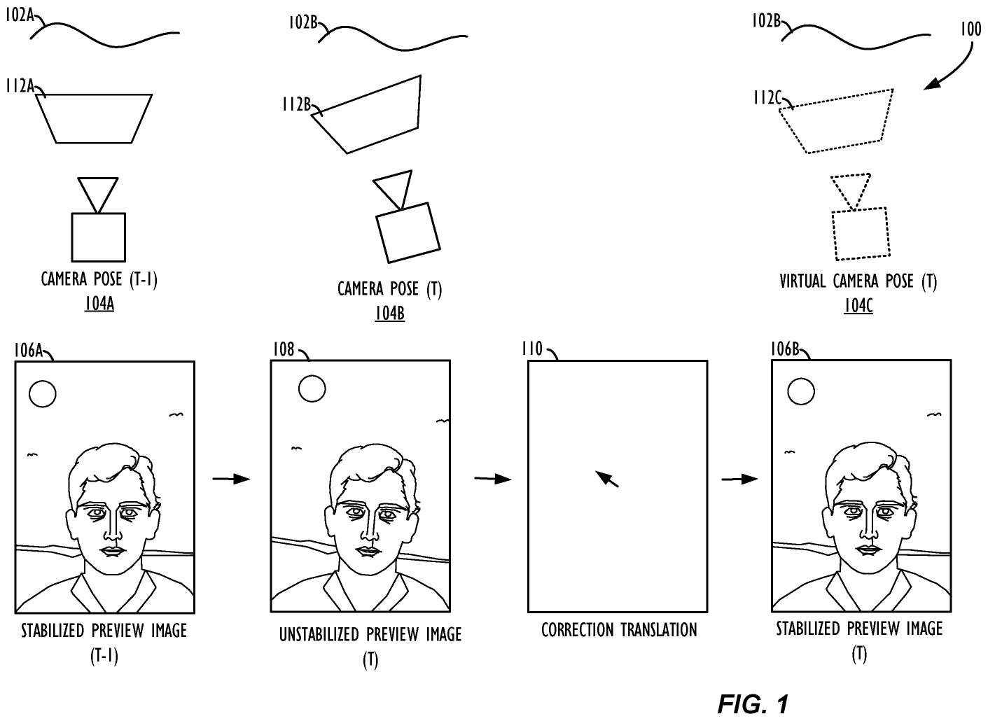

Turning now to FIG. 1, an example 100 of performing stabilization on camera preview images is illustrated. Preview image (T-1) 106A represents a previous preview image frame from an exemplary image capture device. In particular, stabilized preview image (T-1) 106A shows the resulting stabilized preview image 106A of a scene 102A as captured from camera position (T-1) 104A. Thus, the preview image (T-1) 106A may be presented on a display of the image capture device during a preview mode. Meanwhile, unstabilized preview image (T) 108 represents a current preview image frame capturing the scene 102B from camera position (T) 104B. As shown, the camera position has shifted slightly, thereby causing the unstabilized image frame (T) 108 to appear shifted from preview image (T-1) 106A. In particular, the scene content of stabilized preview image (T-1) 106A and unstabilized preview image (T) 108 include a human subject standing on a beach. In this example 100, there is some amount of movement of the scene introduced in the frame as captured by the camera at the first camera position (T-1) 104A and the second camera position (T) 104B. This is clear, for example, based on the tilted view of the water in unstabilized image frame (T) 108 as compared to stabilized preview image (T-1) 106A. Further, the bird on the right of the frame in preview image (T-1) 106A is almost out of the frame in unstabilized preview image frame (T) 108.

According to embodiments described herein, a smoothed trajectory is determined for the camera motion between the two frames. The smoothed trajectory may refer to, for example, relative camera movement from one camera pose to another corresponding to the different frames captured during the camera preview mode. The smoothed trajectory may be determined by collecting motion signals or other sensor data from the camera at each position, such as camera position (T-1) 104A and camera position (T) 104B. The smoothed trajectory may indicate, for example, a refined motion determination for the current frame based, at least in part, on the motion signals or other positional information from one or more prior frames. As will be described in greater detail below, the smoothed trajectory may be determined based on other factors such as lighting, motion type, and the like.

According to some embodiments, while the smoothed trajectory refines the actual camera movement to a refined virtual camera movement for camera stabilization over the frames, the refined should be transformed into an adjustment of the unstabilized image frame. To that end, the smoothed trajectory may be used to determine a correction rotation. The correction rotation may indicate the rotation to be applied from the captured scene in the unstabilized image frame to a target rotation indicative of a target rotation from the captured frame 112B at camera pose (T) 104B to a target virtual camera pose (T) 104C to generate the rotated image frame 112C. Thus, the target rotation may refer to a rotational difference between the actual preview frame 112B and the virtually rotated preview frame 112C.

While the correction rotation may be determined in three dimensions, the modification of the preview unstabilized image frame (T) 108 may occur in two dimensions. In particular, in some embodiments, the correction rotation may be transformed into a correction translation. The correction translation may indicate a directional movement of the scene in the frame to generate a stabilized preview image, as shown by correction translation 110. The correction rotation may be transformed into a correction translation in a number of ways, as will be described in greater detail below.

According to some embodiments, the correction translation 110 may be applied to the unstabilized preview image frame (T) 108 to obtain a stabilized preview image (T) 106B. The resulting stabilized preview image (T) 106B can be presented on a display following the stabilized preview image (T-1) 106A during a preview mode for image capture on the device, thereby providing a stabilized view of the series of preview frames.

### Exemplary Methods for Performing Preview Image Stabilization

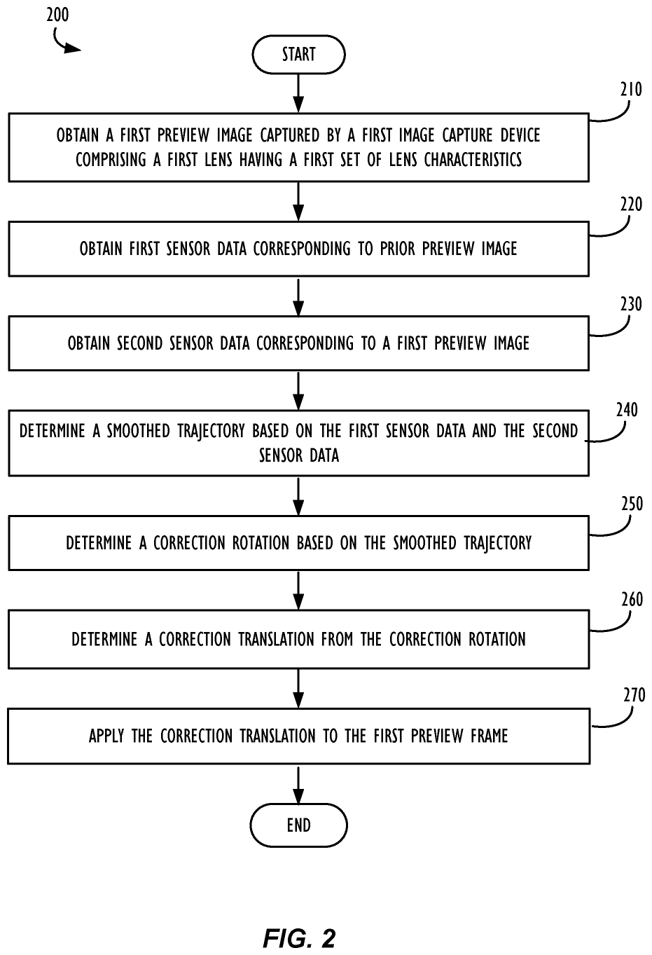

FIG. 2 shows in flowchart form, a technique for applying a corrected translation to a preview image in accordance with one or more embodiments. In particular, the flowchart presented in FIG. 2 depicts an example technique for stabilizing a preview camera feed using a correction translation, in accordance with one or more embodiments. For purposes of explanation, the following steps will be described as being performed by particular components. However, it should be understood that the various actions may be performed by alternate components. In addition, the various actions may be performed in a different order. Further, some actions may be performed simultaneously, some may not be required, or others may be added.

The flowchart 200 begins at block 210, where the first preview image captured by the first image capture device is obtained. The first image capture device may be part of a multi-camera system having multiple image capture devices. Each image capture device of the multi-camera system may have elements having unique lens characteristics. To that end, the first image capture device may comprise a first lens having a first set of lens characteristics.

The flow chart 200 continues at block 220, where a first sensor data is obtained corresponding to a prior preview image. The prior preview image may be the preview frame obtained by the first image capture device prior to the first preview image. The first sensor data may correspond to motion data for the first image capture device. As will be described in greater detail below, the first sensor data may include, for example, gyroscopic signals or other motion signals, optical image stabilization (OIS) position values, or the like.

At block 230, second sensor data is obtained corresponding to the first preview image. The first sensor data may correspond to motion data for the first image capture device. As will be described in greater detail below, the first sensor data may include, for example, gyroscopic signals or other motion signals, optical image stabilization (OIS) position values, or the like.

The flow chart 200 continues at block 240, where a smoothed trajectory is determined based on the first sensor data and the second sensor data. The smooth trajectory may refer to a modified trajectory of the motion between the prior preview image and the first preview image, and may be determined in order to stabilize the preview image stream. The smoothed trajectory may be determined based on a number of factors. For example, as will be described in greater detail below, a smoothing strength parameter may be applied that blends the smoothed trajectory for the prior preview frame and the current trajectory from the first preview frame based on the sensor data. As such, the smoothing strength parameter may control, at least in part, the amount of motion from the current frame should be used in the smooth trajectory. The particular smoothing strength parameter applied may be determined based on a number of considerations, such as a motion state of the camera device, a lighting condition, a capture mode of the camera device, or the like.

The flow chart 200 proceeds to block 250, where a correction rotation is determined based on the smoothed trajectory. The correction rotation may indicate a rotation of the frame and slash or the camera pose resulting from the smoothed trajectory. Said another way, the correction rotation may indicate a rotation between the prior camera pose and a virtual camera pose determined based on the smooth trajectory. And some embodiments, because the stabilization process is applied on an ongoing basis during the camera preview mode, the prior frame pose maybe an actual camera pose or may be a prior virtual camera pose determined after stabilization has been applied. According to some embodiments, the correction rotation may be represented in a number of ways. For example, as will be described below, quaternions may be used to represent the rotation. As another example, a rotation matrix may be used.

At block 260, correction translation is determined from the correction rotation. While the correction rotation may be determined in three dimensions (i.e., the rotation from one camera pose to the other), the modification of the unstabilized preview frame may occur in two dimensions. In particular, in some embodiments, the correction rotation may be transformed into a correction translation, thereby providing a two-dimensional directional vector indicative of a distance and direction the image data should be shifted to obtain a stabilized preview frame in the context of the series of preview frames. The correction rotation may be transformed into a correction translation in a number of ways, such as by computing a transform from the correction rotation data. In some embodiments, the correction translation may be based on a target translation based on a sample point or pixel in the image, such as a midpoint in the image.

The flow chart 200 concludes at block 270, where the corrected translation is applied to the first preview frame, resulting in a stabilized preview frame. According to some embodiments, applying the correction translation to the first preview frame involves shifting the image data in accordance with the correction translation. While shifting the image may result in additional portions of the scene being a parent which are not visible in the original first preview frame, according to some embodiments, the preview image frames may be associated with over scan data, such that what appears in the display is only a portion of the available preview image data. Accordingly, shifting the preview frame may result in display of image content which may not be visible if the stabilization technique were not applied.

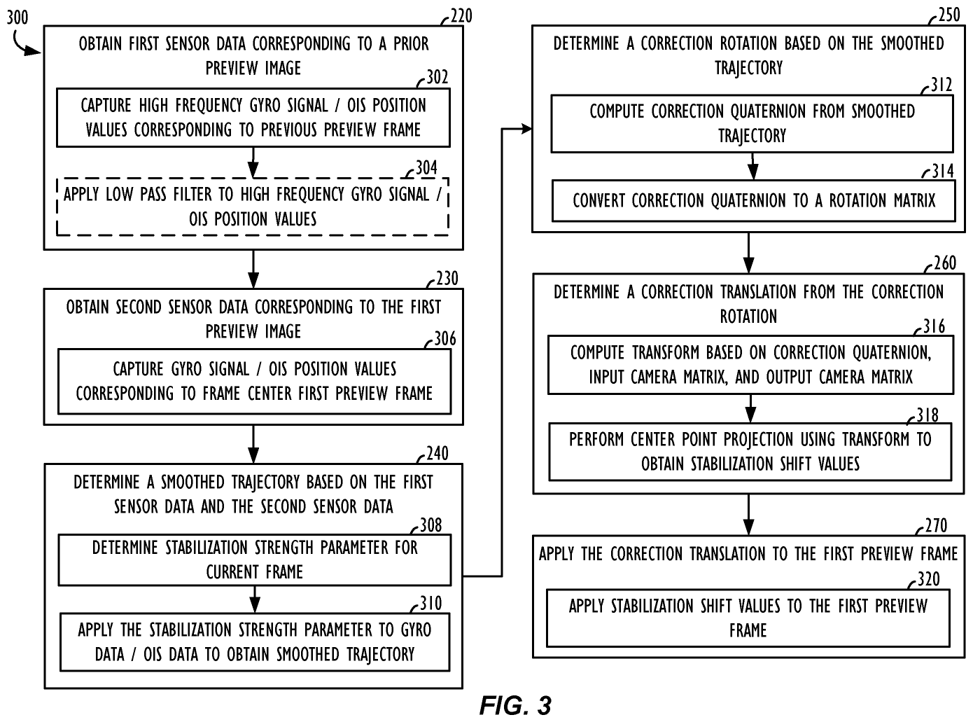

FIG. 3 shows, in flowchart form, additional detail for a technique for applying a corrected translation to a preview image in accordance with one or more embodiments. In particular, FIG. 3 shows example techniques for performing some of the steps described above with respect to FIG. 2. For purposes of explanation, the following steps will be described as being performed by particular components. However, it should be understood that the various actions may be performed by alternate components. In addition, the various actions may be performed in a different order. Further, some actions may be performed simultaneously, some may not be required, or others may be added.

The flowchart 300 begins at block 220, where first sensor data is obtained corresponding to a prior preview image. In this example workflow, obtaining the first sensor data includes, as shown at block 302, capturing high frequency gyro signals corresponding to the previous preview frame. In some embodiments, the high frequency gyro signals collected at block 220 may correspond to a frame center. The gyro signals may indicate characteristics of the motion of the camera when the corresponding frame was captured. In some embodiments, optical image stabilization (OIS) signals for the frame may be used if OIS signals are available on the device. Optionally, as shown at block 304, a low pass filter may be applied to the high frequency signals to remove unwanted frequencies. According to some embodiments, applying a low pass filter may reduce noise which may be present in the sensor data.

At block 230, second sensor data is obtained corresponding to the first preview image. The first sensor data may correspond to motion data for the first image capture device. As shown at block 306, the first sensor data may include, for example, gyroscopic signals or other motion signals, optical image stabilization (OIS) position values, or the like. Similar as described above with respect to block 220, the gyro signal and/or OIS position values may be filtered using a low pass filter to reduce noise.

The flow chart 300 continues at block 240, where a smoothed trajectory is determined based on the first sensor data and the second sensor data. The smoothed trajectory may refer to a modified trajectory of the motion between the prior preview image and the first preview image, and may be determined in order to stabilize the preview image stream. As shown at block 308, a smoothing strength parameter may be determined for the current preview frame. The smoothing strength parameter may be selected based on a number of factors, such as a motion state of the camera device, a lighting condition, a capture mode of the camera device, or the like.

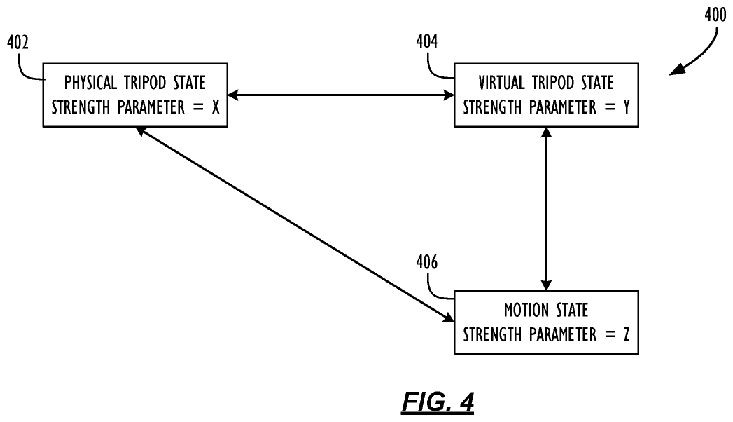

According to one or more embodiments, motion state may include one or more characteristics of ongoing motion by the device. Turning to FIG. 4, a flow diagram of a technique for classifying a motion state is presented, in accordance with some embodiments. In particular, FIG. 4 can be interpreted as an example of a state machine for motion states used to stabilize a preview image, according to one or more embodiments. For purposes of the description in FIG. 4, the various states include “physical tripod,” “virtual tripod,” and “motion.” However, it should be understood that these terms are merely example identifiers for the different states which may be identified based on motion signals, and may not indicate an actual state of an image capture device. Each of these motion states may be associated with a different stabilization strength, meaning that motion detected in the current frame and/or prior frame will be weighted differently based on the category of motion identified.

The flow 400 begins at 402, where an image capture device is in a physical tripod mode. According to one or more embodiments, the physical tripod mode may refer to a motion state which is extremely stable, such as when an image capture device is on a physical tripod. The motion characteristics may indicate that overall motion falls below a predefined low threshold to make a determination that the image capture device is sufficiently stable as to infer that the image capture device is on a physical tripod or otherwise in a position such that movement is limited or unlikely. For example, the device may be set on a physical object or otherwise not handheld such that handheld jitter or motion is unlikely. As shown here, a first strength parameter (labeled “X”) is associated with the physical tripod state at block 402 such that the “X” smoothing strength parameter may be applied, at least in part, to the smoothed trajectory for the frame. According to some embodiments, the smoothing strength parameter associated with the physical tripod state may be lower than the smoothing strength parameters for other states because no movement is expected.

According to one or more embodiments, a device can transition between motion states during use of the device, for example within a single preview session. As such, the state machine shows a possible transition from the physical tripod state at block 402 to a virtual tripod state at block 404. In some embodiments, the virtual tripod state at block 404 may be associated with limited movement, such as a small jitter, where the image capture device remains within a limited position and orientation, for example when a user is holding an image capture device with the intent to remain stationary. As such, a separate one or more threshold values may be used in association with detected sensor data to determine whether the image capture device is in a virtual tripod state 404. As shown here, a second strength parameter (labeled “Y”) is associated with the virtual tripod state at block 404 such that the “Y” smoothing strength parameter may be applied, at least in part, to the smoothed trajectory for the frame. According to some embodiments, the smoothing strength parameter associated with the virtual tripod state may be higher than the smoothing strength parameter for the physical tripod state to account for some motion, but lower than a smoothing strength parameter for a motion state, where motion is intentional.

Similarly, the state machine shows possible transitions from the physical tripod state at block 402 and the virtual tripod state at block 404 to a motion state at block 406. In some embodiments, the motion state at block 406 may be associated with significant movement, such as a rotation, a panning motion, or the like, for example when the user holding an image capture device intentionally moves the image capture device. As such, a separate one or more threshold values may be used in association with detected sensor data to determine whether the image capture device is in a motion state 406. As shown here, a third strength parameter (labeled “Z”) is associated with the motion state at block 404 such that the “Z” smoothing strength parameter may be applied, at least in part, to the smoothed trajectory for the frame. According to some embodiments, the smoothing strength parameter associated with the motion state may be higher than the smoothing strength parameter for the physical tripod state or the virtual tripod state, to account for intentional large movements.

Returning to FIG. 3 at block 308, the smoothing strength parameter may be determined based on additional or alternative considerations. For example, lighting conditions of an environment of the image capture device may affect a selected smoothing strength parameter. According to some embodiments, an unstabilized image and low light may be more likely to trigger artifacts being present in the image. For example, a jitter of an image capture device in low light may cause the resulting image to include a blur or shimmer which may reduce the quality and/or usefulness of the preview image. Thus, a weaker smoothing strength parameter may be used in low light conditions than in brighter conditions. According to some embodiments, low light conditions may be detected by the image capture device, for example, based on frame rate or exposure time. For example, if the exposure time exceeds a predefined threshold, the device may determine that a low light condition exists. Similarly, if a frame rate falls below a predefined threshold, the device may determine that a low light condition exists. If a low light condition is detected, the stabilization strength may be reduced, thereby restricting that amount of change in the image data from one preview frame to another. In another example, the light conditions can be detected by computing an average motion blur for each frame. In some embodiments, the average motion blur may be computed using gyro or optical image stabilization (OIS) values. The motion blur values may be compared to a predefined threshold, such that if the threshold is exceeded, the smoothing strength parameter is reduced.

As another example, a current capture mode may affect the smoothing strength parameter applied to the preview frame. For example, the camera is in a photo capture mode, then a stronger smoothing strength parameter may be applied. This may occur because in a photo capture mode, a user is less likely to intend to move the camera. By contrast, in a video capture mode, a lower smoothing strength parameter may be applied to adjust for a situation in which a user intends to move the image capture device while capturing an image. According to one or more embodiments, the various considerations for determining the smoothing strength parameter may be used in the alternative, or in various combinations, to generate a determined smoothing strength parameter for a particular frame.

The flow chart 300 continues to block 310, where the determined smoothing strength parameter is applied to the sensor data, such as the gyro data or OIS data, to obtain a smoothed trajectory. According to one or more embodiments, the smooth trajectory may refer to, for example, relative camera movement from one camera pose to another corresponding to the different frames captured during the camera preview mode.

The smoothed trajectory may indicate, for example, a refined motion determination for the current frame based, at least in part, on the motion signals or other positional information from one or more prior frames and in accordance with the smoothing strength parameter. For example, Q[n] may represent the camera motion signals at a frame center (or, for example, another sample point), and s may represent a smoothing strength parameter. The smoothed trajectory for a current frame may be represented by Qavg[n], where Qavg[n]=s*Qavg[n−1]+(1−s)*Q[n]. That is, the smoothing strength parameter is applied to a smoothed trajectory from a prior frame, plus the inverse applied to the current signal data.

The flow chart 300 proceeds to block 250, where a correction rotation is determined based on the smoothed trajectory. The correction rotation may indicate a rotation of the frame and/or the camera pose resulting from the smoothed trajectory. Said another way, the correction rotation may indicate a rotation between the prior camera pose and a virtual camera pose determined based on the smooth trajectory. According to some embodiments, as shown at block 312, determining the correction may include computing a correction quaternion from the smoothed trajectory. According to one or more embodiments, the correction quaternion may be configured to represent the rotational characteristics of the correction of the preview frame at a smoothed position from the original preview frame position. Returning to the notations used above with respect to the smoothed trajectory, the correction quaternion may be represented as

Qc=Qavg[n]−Q[n].

That is, the correction quaternion indicates rotational values between the smoothed trajectory and the original trajectory. The flowchart 300 proceeds to block 314, where the correction quaternion is converted to a rotation matrix, referred herein as “Qr”.

At block 260, correction translation is determined from the correction rotation. While the correction rotation may be determined in three dimensions (i.e., the rotation from one camera pose to the other), the modification of the unstabilized preview frame may occur in two dimensions. As shown at block 316, a transform may be computed based on the correction quaternion, the input camera matrix, and an output camera matrix. Because the correction quaternion has been converted into a rotation matrix, matrix mathematics can be used to determine the transform. According to one or more embodiments, the transform is represented as M=Kᵢₙₚᵤₜ*Qr*(1/Kₒᵤₜₚᵤₜ) where Kᵢₙₚᵤₜ is an input camera matrix and Kₒᵤₜₚᵤₜ is an output camera matrix.

The correction rotation may be transformed into a correction translation, thereby providing a two-dimensional directional vector indicative of a distance and direction the image data should be shifted to obtain a stabilized preview frame in the context of the series of preview frames. At block 318, center point projection is performed using the transform (M) to obtain stabilization shift values for the translation. According to one or more embodiments, the shift values t_{xy} may be representative of the distance and direction the image should be shifted in the frame for stabilization. According to some embodiments, t_{xy} may be calculated as t_{xy}=M*P−P, where P is the center point, or other sample point in the frame.

The flow chart 300 concludes at block 270, where the corrected translation is applied to the first preview frame, resulting in a stabilized preview frame. As shown at bock 320, applying the correction translation to the first preview frame may include applying the stabilization shift values to the first preview frame. Because of the shift, additional portions of the scene may become visible which are not visible in the original first preview frame. Thus, more image data may be captured during the preview than is presented on a display during the preview mode.

### Exemplary Camera Sag Removal Operations

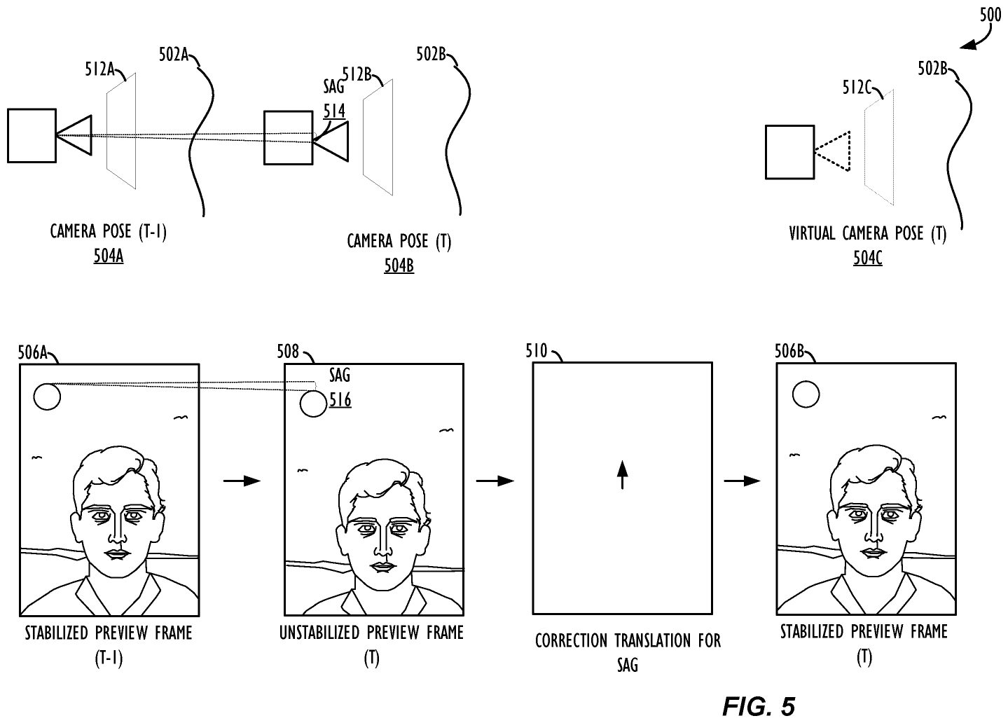

The stabilization techniques described herein can alternatively, or additionally, be used to address other inconsistencies between a preview image and a captured image. FIG. 5 is an exemplary framework for adjusting for sag in a preview image, according to one or more embodiments. Sag may occur in an image, for example, because of gravity pulling on camera components as the image is being captured. According to some embodiments, the sagging characteristic may be addressed during image processing once the image is captured. To that end, the image presented during a preview may not match the output image after the image is captured.

In FIG. 5 an example 500 of adjusting image sag on camera preview images is illustrated. Stabilized preview image (T-1) 506A represents a previous preview image frame from an exemplary image capture device. In particular, stabilized preview image (T-1) 506A shows the resulting stabilized preview image 506A of a scene 502A as captured from camera pose (T-1) 504A. Thus, the preview image (T-1) 506A may be presented on a display of the image capture device during a preview mode. Meanwhile, unstabilized preview image (T) 508 represents a current preview image frame capturing the scene 502B from camera position (T) 504B. For purposes of this example, the camera may have shifted slightly, due to camera sag, and/or other movements during the preview mode. This is shown in the example by the sag 514 of the camera between camera pose (T-1) 504A and camera pose (T) 504B. As shown, the unstabilized image frame (T) 508 to appear shifted from preview image (T-1) 506A, as is apparent by sag 516.

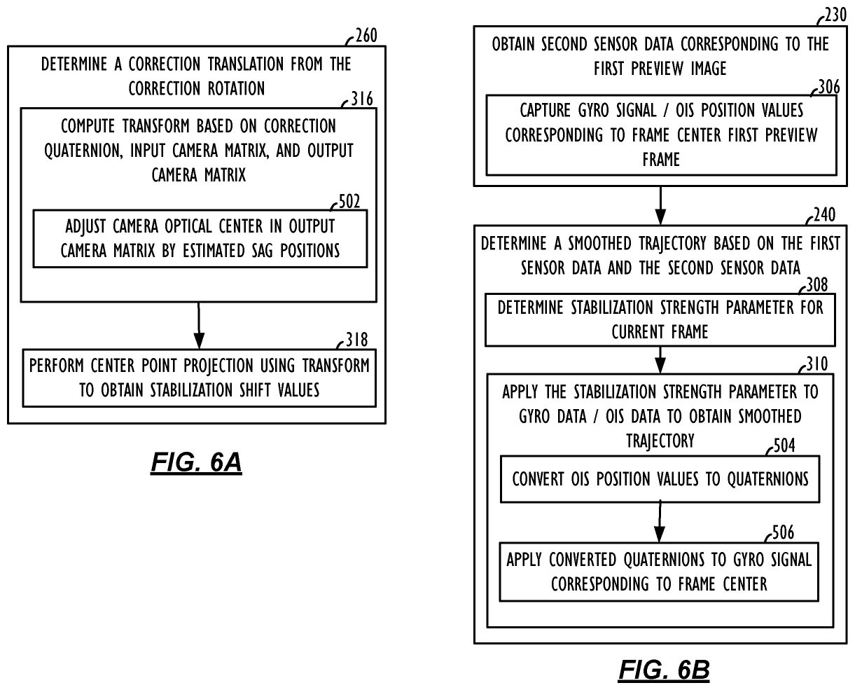

According to one or more embodiments, the sag may be addressed using the correction translation 510. In some embodiments, the translation for the sag may be applied separately or as part of the correction translation for motion. The correction for the sag may be determined in a variety of ways, which will be described in greater detail below with respect to FIGS. 6A-6B. Generally, the correction translation to account for the sag may be determined based on characteristics of the camera. The correction translation 510 may indicate the shift to be applied from the captured scene in the unstabilized image frame to a target rotation indicative of a target rotation from the captured frame 512B at camera pose (T) 504B to a target virtual camera pose (T) 504C to generate the adjusted image frame 512C.

According to some embodiments, the correction translation 510 may be applied to the unstabilized preview image frame (T) 508 to obtain a stabilized preview frame (T) 506B. The resulting stabilized preview frame (T) 506B can be presented on a display following the stabilized preview image (T-1) 506A during a preview mode for image capture on the device, thereby providing a stabilized view of the series of preview frames.

FIGS. 6A-6B are flowcharts illustrating techniques for determining a correction translation to adjust for camera sag, in accordance with one or more embodiments. For purposes of explanation, the following steps will be described as being performed by particular components. However, it should be understood that the various actions may be performed by alternate components. In addition, the various actions may be performed in a different order. Further, some actions may be performed simultaneously, some may not be required, or others may be added.

FIG. 6A illustrates an example technique for adjusting for camera sag using camera intrinsics. At block 260, as described above, correction translation is determined from the correction rotation. While the correction rotation may be determined in three dimensions (i.e., the rotation from one camera pose to the other, the modification of the unstabilized preview frame may occur in two dimensions. As shown at block 316, a transform may be computed based on the correction quaternion, the input camera matrix, and an output camera matrix. Because the correction quaternion has been converted into a rotation matrix, matrix mathematics can be used to determine the transform. In order to compensate for camera sag, at block 502, the camera optical center in the output camera matrix is adjusted by the estimated sag position. According to one or more embodiments the estimated sag position may be predefined, for example based on known properties of the camera. Additionally, or alternatively, the sag position may be estimated based on other factors, such as OIS values or other parameters which may affect the position of the lens stack of the camera. The flowchart then concludes at block 318 where, as described above, center point projection is performed using the transform to obtain stabilization shift values for the translation. As such, the resulting translation takes into consideration the estimated camera sag.

Turning to FIG. 6B, an example technique for adjusting for camera sag is illustrated using OIS values. At block 230, as described above, second sensor data is obtained corresponding to the first preview image. The second sensor data may correspond to motion data for the image capture device. As shown at block 306, the first sensor data may include, for example, gyroscopic signals or other motion signals, optical image stabilization (OIS) position values, or the like. For purposes of this example technique, OIS position values are captured corresponding to the frame center, or another sample position of the frame, for the first preview frame, along with gyro signals.

The flow chart continues at block 240, where a smoothed trajectory is determined based on the first sensor data and the second sensor data. The smoothed trajectory may refer to a modified trajectory of the motion between the prior preview image and the first preview image and may be determined in order to stabilize the preview image stream. As shown at block 308, as described above, a smoothing strength parameter may be determined for the current preview frame. The smoothing strength parameter may be selected based on a number of factors, such as motion state of the camera device, a lighting condition, a capture mode of the camera device, or the like.

At block 310, the determined smoothing strength parameter is applied to the OIS data, to obtain a smoothed trajectory. According to one or more embodiments, the smooth trajectory may refer to, for example, relative camera movement from one camera pose to another corresponding to the different frames captured during the camera preview mode. The smoothed trajectory may indicate, for example, a refined motion determination for the current frame based, at least in part, on the motion signals or other positional information from one or more prior frames and in accordance with the smoothing strength parameter. In this example, applying the filter strength includes, at block 504, converting the OIS position values for the second sensor data to quaternions. The flowchart concludes at block 506, where the converted quaternions from the OIS position values are applied to the gyro signals corresponding to the frame center or other sample point. The stabilization strength parameter is then used to obtain the smoothed trajectory.

### Exemplary Electronic Computing Devices

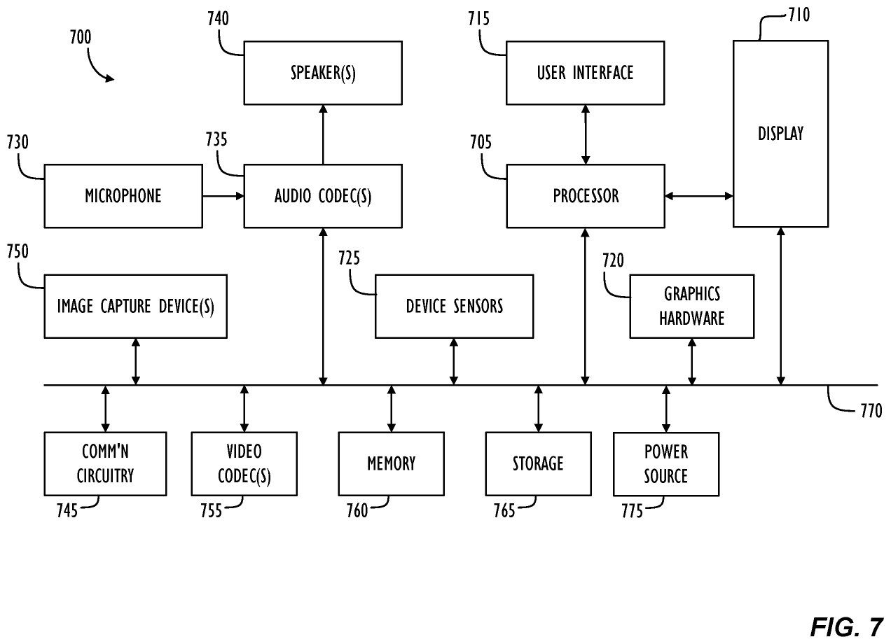

Referring now to FIG. 7, a simplified functional block diagram of illustrative programmable electronic computing device 700 is shown according to one embodiment. Electronic device 700 could be, for example, a mobile telephone, personal media device, portable camera, or a tablet, notebook or desktop computer system. As shown, electronic device 700 may include processor 705, display 710, user interface 715, graphics hardware 720, device sensors 725 (e.g., proximity sensor/ambient light sensor, accelerometer, inertial measurement unit, and/or gyroscope), microphone 730, audio codec(s) 735, speaker(s) 740, communications circuitry 745, image capture device(s) 750, which may, e.g., comprise multiple camera units/optical image sensors having different characteristics or abilities (e.g., Still Image Stabilization (SIS), high dynamic range (HDR), optical image stabilization (OIS) systems, optical zoom, digital zoom, etc.), video codec(s) 755, memory 760, storage 765, and communications bus 780.

Processor 705 may execute instructions necessary to carry out or control the operation of many functions performed by electronic device 700 (e.g., such as the processing of images in accordance with the various embodiments described herein). Processor 705 may, for instance, drive display 710 and receive user input from user interface 715. User interface 715 can take a variety of forms, such as a button, keypad, dial, a click wheel, keyboard, display screen and/or a touch screen. User interface 715 could, for example, be the conduit through which a user may view a captured video stream and/or indicate particular image frame(s) that the user would like to capture (e.g., by clicking on a physical or virtual button at the moment the desired image frame is being displayed on the device's display screen). In one embodiment, display 710 may display a video stream as it is captured while processor 705 and/or graphics hardware 720 and/or image capture circuitry contemporaneously generate and store the video stream in memory 760 and/or storage 765. Processor 705 may be a system-on-chip (SOC) such as those found in mobile devices and include one or more dedicated graphics processing units (GPUs). Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 perform computational tasks. In one embodiment, graphics hardware 720 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device(s) 750 may comprise one or more camera units configured to capture images, e.g., images which may be processed to help further calibrate said image capture device in field use, e.g., in accordance with this disclosure. Image capture device(s) 750 may include two (or more) lens assemblies 780A and 780B, where each lens assembly may have a separate focal length. For example, lens assembly 780A may have a shorter focal length relative to the focal length of lens assembly 780B. Each lens assembly may have a separate associated sensor element, e.g., sensor elements 790A/790B. Alternatively, two or more lens assemblies may share a common sensor element. Image capture device(s) 750 may capture still and/or video images. Output from image capture device(s) 750 may be processed, at least in part, by video codec(s) 755 and/or processor 705 and/or graphics hardware 720, and/or a dedicated image processing unit or image signal processor incorporated within image capture device(s) 750. Images so captured may be stored in memory 760 and/or storage 765.

Memory 760 may include one or more different types of media used by processor 705, graphics hardware 720, and image capture device(s) 750 to perform device functions. For example, memory 760 may include memory cache, read-only memory (ROM), and/or random-access memory (RAM). Storage 765 may store media (e.g., audio, image, and video files), computer program instructions or software, preference information, device profile information, and any other suitable data. Storage 765 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 760 and storage 765 may be used to retain computer program instructions or code organized into one or more modules and written in any desired computer programming language. When executed by, for example, processor 705, such computer program code may implement one or more of the methods or processes described herein. Power source 775 may comprise a rechargeable battery (e.g., a lithium-ion battery, or the like) or other electrical connection to a power supply, e.g., to a mains power source, which is used to manage and/or provide electrical power to the electronic components and associated circuitry of electronic device 700.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A non-transitory computer readable medium comprising computer readable code executable by one or more processors to:
obtain a first preview frame captured by a camera device;
obtain first camera motion signals associated with the first preview frame and prior camera motion signals associated with a prior preview frame;
determine a smoothed trajectory for the first preview frame based on the first camera motion signals and second camera motion signals;
determine a correction rotation based on the smoothed trajectory for the first preview frame;
determine a correction translation based on the correction rotation;
apply the correction translation to the first preview frame to obtain a corrected first preview frame; and
cause the corrected first preview frame to be displayed.

2. The non-transitory computer readable medium of claim 1, wherein the computer readable code to determine a smoothed trajectory for the first preview frame further comprises computer readable code to:
determine a trajectory for the first preview frame;
obtain a smoothed trajectory for the prior preview frame; and
determine the smoothed trajectory for the first preview frame based on the trajectory for the first preview frame and the smoothed trajectory for the prior preview frame.

3. The non-transitory computer readable medium of claim 2, wherein the computer readable code to determine the smoothed trajectory for the first preview frame based on the trajectory for the first preview frame and the smoothed trajectory for the prior preview frame further comprises computer readable code to:
apply a smoothing strength parameter that blends between to the smoothed trajectory for the prior preview frame and the trajectory for the first preview frame.

4. The non-transitory computer readable medium of claim 3, wherein the smoothing strength parameter is determined based on at least one selected from a group consisting of: a motion state of the camera device and a lighting condition around the camera device.

5. The non-transitory computer readable medium of claim 3, wherein the smoothing strength parameter is determined based on a capture mode associated with the first preview frame.

6. The non-transitory computer readable medium of claim 1, wherein the computer readable code to determine the correction translation based on the correction rotation further comprises computer readable code to:
determine a transform matrix based on the determined correction rotation; and
apply the transform matrix to a sample point in the first preview image to determine the correction translation.

7. The non-transitory computer readable medium of claim 1, wherein the corrected translation is adjusted in accordance with an estimated sag of the camera device.

8. A method comprising:
obtaining a first preview frame captured by a camera device;
obtaining first camera motion signals associated with the first preview frame and prior camera motion signals associated with a prior preview frame;
determining a smoothed trajectory for the first preview frame based on the first camera motion signals and second camera motion signals;
determining a correction rotation based on the smoothed trajectory for the first preview frame;
determining a correction translation based on the correction rotation;
applying the correction translation to the first preview frame to obtain a corrected first preview frame; and
causing the corrected first preview frame to be displayed.

9. The method of claim 8, wherein determining a smoothed trajectory for the first preview frame further comprises:
determining a trajectory for the first preview frame;
obtaining a smoothed trajectory for the prior preview frame; and
determining the smoothed trajectory for the first preview frame based on the trajectory for the first preview frame and the smoothed trajectory for the prior preview frame.

10. The method of claim 9, wherein determining the smoothed trajectory for the first preview frame based on the trajectory for the first preview frame and the smoothed trajectory for the prior preview frame further comprises:
applying a smoothing strength parameter that blends between to the smoothed trajectory for the prior preview frame and the trajectory for the first preview frame.

11. The method of claim 10, wherein the smoothing strength parameter is determined based on at least one selected from a group consisting of: a motion state of the camera device and a lighting condition around the camera device.

12. The method of claim 10, wherein the smoothing strength parameter is determined based on a capture mode associated with the first preview frame.

13. The method of claim 8, wherein determining the correction translation based on the correction rotation further comprises:
determine a transform matrix based on the determined correction rotation; and
apply the transform matrix to a sample point in the first preview image to determine the correction translation.

14. The method of claim 8, wherein the corrected translation is adjusted in accordance with an estimated sag of the camera device.

15. A system comprising:
one or more processors; and
one or more computer readable media comprising computer readable code executable by the one or more processors to:
obtain a first preview frame captured by a camera device;
obtain first camera motion signals associated with the first preview frame and prior camera motion signals associated with a prior preview frame;
determine a smoothed trajectory for the first preview frame based on the first camera motion signals and second camera motion signals;
determine a correction rotation based on the smoothed trajectory for the first preview frame;
determine a correction translation based on the correction rotation;
apply the correction translation to the first preview frame to obtain a corrected first preview frame; and
cause the corrected first preview frame to be displayed.

16. The system of claim 15, wherein the computer readable code to determine a smoothed trajectory for the first preview frame further comprises computer readable code to:
determine a trajectory for the first preview frame;
obtain a smoothed trajectory for the prior preview frame; and
determine the smoothed trajectory for the first preview frame based on the trajectory for the first preview frame and the smoothed trajectory for the prior preview frame.

17. The system of claim 16, wherein the computer readable code to determine the smoothed trajectory for the first preview frame based on the trajectory for the first preview frame and the smoothed trajectory for the prior preview frame further comprises computer readable code to:
apply a smoothing strength parameter that blends between to the smoothed trajectory for the prior preview frame and the trajectory for the first preview frame.

18. The system of claim 17, wherein the smoothing strength parameter is determined based on at least one selected from a group consisting of: a motion state of the camera device and a lighting condition around the camera device.

19. The system of claim 17, wherein the smoothing strength parameter is determined based on a capture mode associated with the first preview frame.

20. The system of claim 15, wherein the corrected translation is adjusted in accordance with an estimated sag of the camera device.
